(19) United States
(12) Patent Application Publication
(10) Pub. No.: US 2009/0067279 A1
(43) Pub. Date: Mar. 12, 2009

(54) Stand mixer with electronic controls

(76) Inventors: Theodore B. Mulle, New Milford, CT (US); Charles Greenway, London (GB)

Correspondence Address: Lawrence Cruz;Conair Corporation, One Cummings Point Road, STAMFORD, CT, 06902, US

(21) Appl. No.: 11/900,080

(22) Filed: Sep. 10, 2007

(51) Int. Cl. B01F 13/00; B01F 15/00

(52) U.S. Cl. 366/142; 366/349

(57) ABSTRACT

There is provided a stand mixer comprising a housing (12) with a top portion (14), a base (16) and a mixing bowl (18). A motor within the housing rotates one or more output shafts to spin various attachments such as mixing whisks and dough hooks. The preferred embodiment features a control panel (30) located on the housing in a limited amount of surface area for efficient use of space. The control panel (30) comprises a power/speed control section (32) and a time control section (34). The power/speed control section (32) is preferably in the form of a dial (36) and can be rotated to be set to one of a multitude of speed settings. The power/speed control section (32) contains an “ON/OFF” button (40) to control the main power to the stand mixer and a “Pulse/Fold” button (42), which when pressed, causes the attachments to rotate approximately 1.5 to 2.5 revolutions and then come to a complete stop. The control panel also comprises a time control section (34) that controls the amount of time the stand mixer will operate for.

### CROSS-REFERENCE TO RELATED APPLICATIONS

None.

### BACKGROUND OF THE INVENTION

1. Field of the Invention

The present invention relates to a kitchen device for mixing ingredients. More particularly, the present invention relates to a stand mixer having electronic control functions set in an efficient configuration.

2. Description of Related Art

It is known to provide kitchen devices that can be used to mix a variety of ingredients. A kitchen device, such as a stand mixer, can include a housing that contains a motor, which rotates one or more output shafts to spin various attachments such as mixing whisks and dough hooks for kneading dough. A bowl can be utilized to hold the various ingredients as they are being mixed. A control panel having a multitude of buttons can be used to control the device.

Inherent shortcomings associated with these known devices include the inefficiency with which the control buttons are placed to accomplish a variety of tasks. There is a need for a device that can fit many control functions into a limited amount of surface area for efficient use of available space and ease of consumer use.

### OBJECT AND SUMMARY OF THE INVENTION

It is an object of the present invention to overcome the shortcomings of the prior art mentioned above. These and other objects are achieved by the present invention described herein.

The present invention achieves these and other objectives by providing a stand mixer comprising a housing with a top portion, a base and a mixing bowl. The front portion of the base can be shaped to securely hold the mixing bowl in place. A motor within the housing rotates one or more output shafts to spin various attachments such as mixing whisks and dough hooks.

The preferred embodiment features a control panel located on the housing. The control panel comprises a power/speed control section and a time control section. The power/speed control section is preferably in the form of a dial and can be rotated to be set to one of a multitude of speed settings. The power/speed control section contains an “ON/OFF” button to control the main power to the stand mixer. The power/speed control section also comprises a “Pulse/Fold” button, which when pressed, causes the attachments to rotate approximately 1.5 to 2.5 revolutions and then come to a complete stop.

The control panel also comprises a time control section that controls the amount of time the stand mixer will operate for. The amount of mixing time can be entered into the display be depressing the minute and second buttons to the desired time. The stand mixer will operate for the set amount of time and then automatically shut off.

### BRIEF DESCRIPTION OF THE DRAWINGS

The present invention is more fully understood by reference to the following detailed description of an illustrative embodiment with the drawings identified below.

FIG. 1 is a perspective view of a stand mixer in accordance with a preferred embodiment of the present invention.

FIG. 2 is a side view of a stand mixer in accordance with a preferred embodiment of the present invention.

FIG. 3 is a partially assembled perspective view of a control panel for the stand mixer shown in FIG. 1, in accordance with a preferred embodiment of the present invention.

FIG. 4A is a top view of a control panel for the stand mixer shown in FIG. 1, in accordance with a preferred embodiment of the present invention.

FIG. 4B is a front view of a control panel for the stand mixer shown in FIG. 1, in accordance with a preferred embodiment of the present invention.

FIG. 4C is a left side view of a control panel for the stand mixer shown in FIG. 1, in accordance with a preferred embodiment of the present invention.

FIG. 5 is an electronic circuit diagram, in accordance with a preferred embodiment of the present invention.

FIG. 6 is an electronic circuit diagram, in accordance with a preferred embodiment of the present invention.

### DETAILED DESCRIPTION OF THE INVENTION

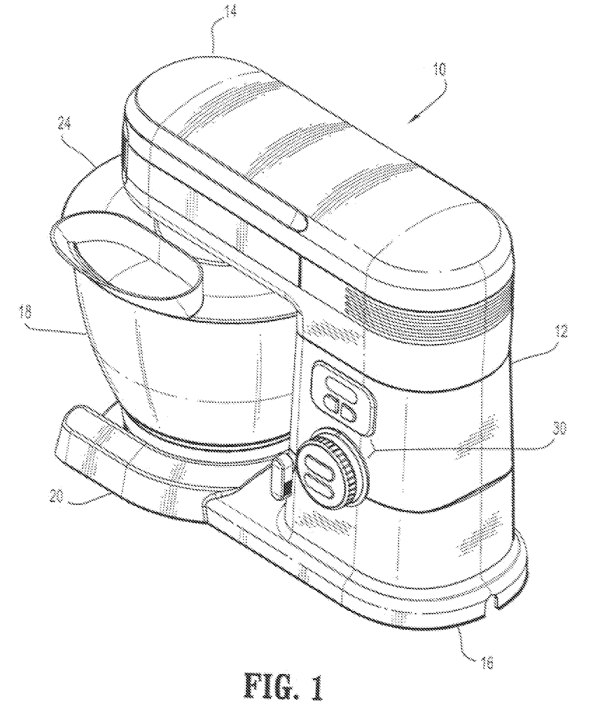

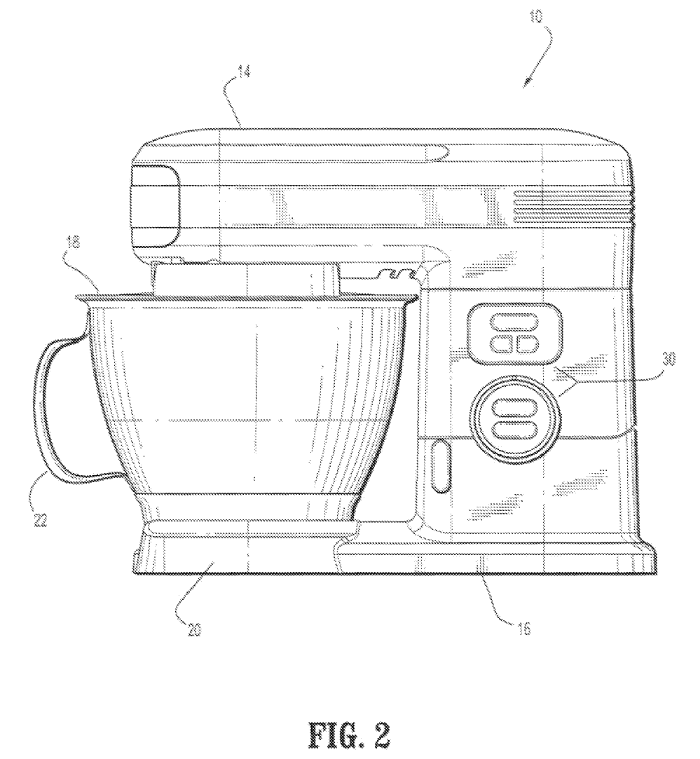

FIGS. 1 and 2 show a stand mixer 10 in accordance with a preferred embodiment of the present invention. The stand mixer 10 generally contains a housing 12 with a top portion 14, a base 16 and a mixing bowl 18. The stand mixer 10 is generally shaped to be weight-balanced and sit firmly on the work surface, such as a kitchen counter.

The front portion 20 of the base 16 can be shaped to securely hold the mixing bowl 18 in place. In one embodiment of the present invention, the mixing bowl 18 may be selectively locked into place. In a preferred embodiment, the mixing bowl 18 can contain a handle 22, as shown in FIG. 2, for easier handling of the mixing bowl 18. In one embodiment of the present invention, a cover 24 is used to prevent any of the contents from spilling out of the mixing bowl 18. As known to those skilled in the art, a motor (not shown) within the housing 12 rotates one or more output shafts (not shown) to spin various attachments such as mixing whisks, to mix a variety of ingredients, and dough hooks for kneading dough.

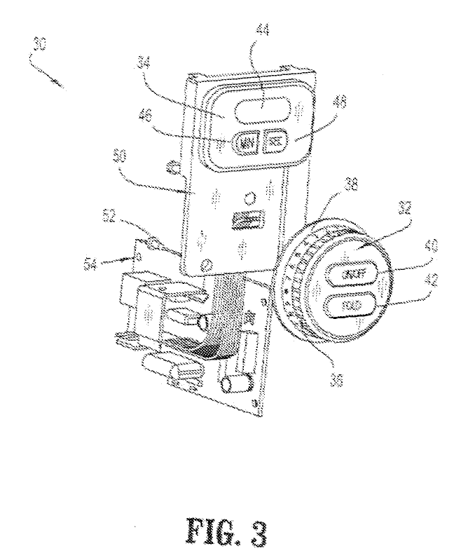

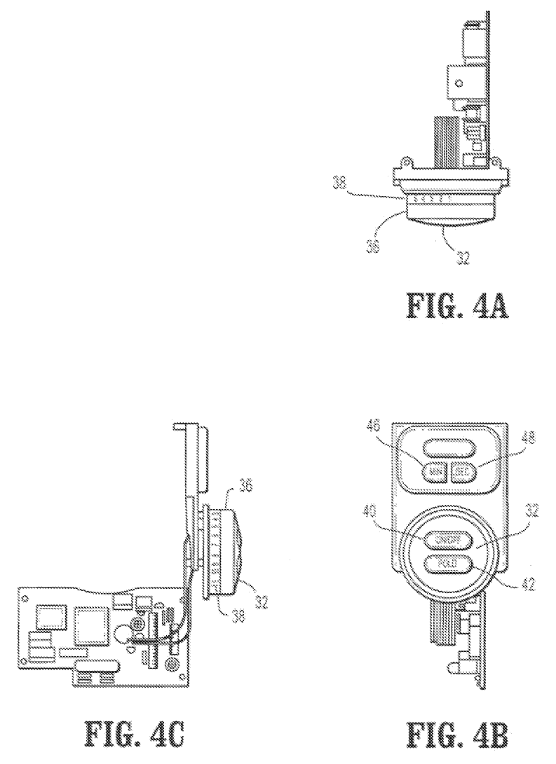

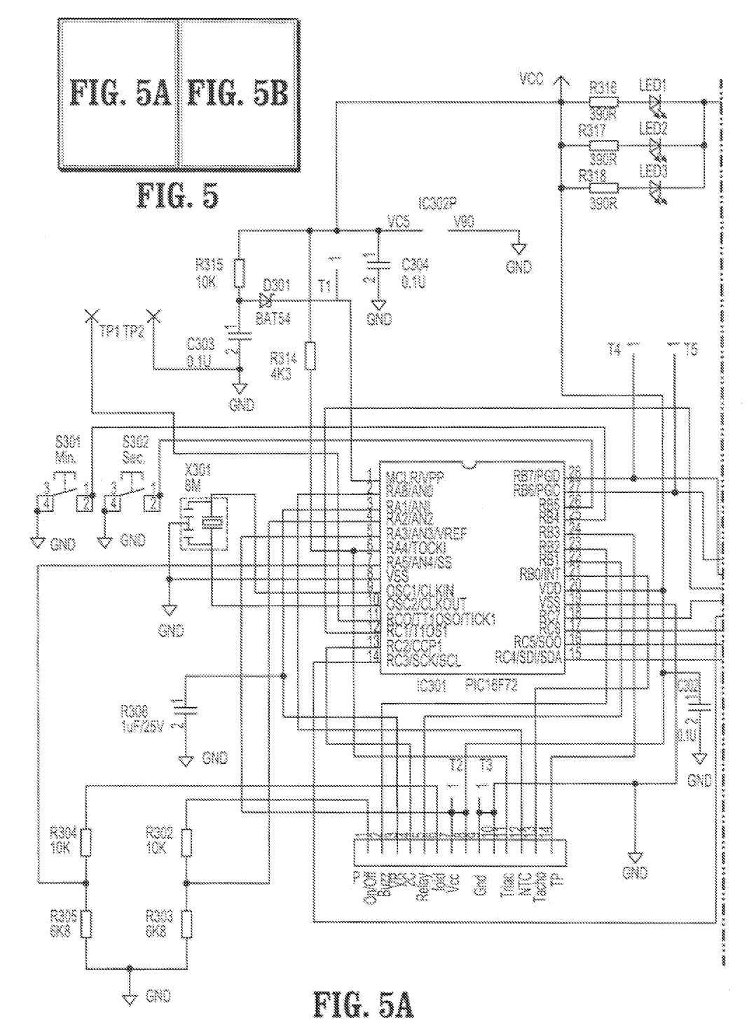

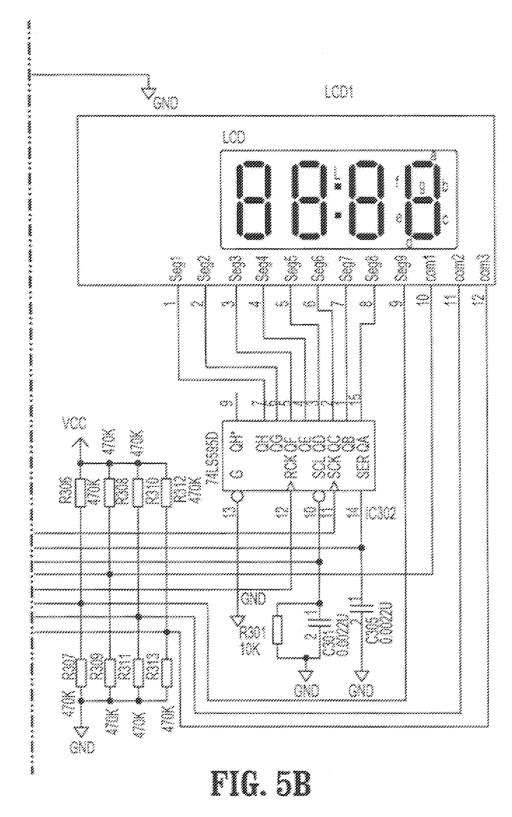

Included on the housing 12 is a control panel 30, as shown in FIGS. 3 through 4C. In the preferred embodiment, the control panel 30 comprises the power/speed control section 32 and the time control section 34. The power/speed control section 32 is preferably in the form of a dial 36. However, other shapes for the power/speed control section 32 can also be considered. The dial 36 can be rotated to be set to one of a multitude of speed settings 38 to enable a user to set the stand mixer 10 to operate at a particular speed. In a preferred embodiment, the control panel 30 provides a “Slow Start” to the speeds so that there is not a rapid starting, which may possibly throw the contents of the mixing bowl 18 over the work surface.

The power/speed control section 32 contains an “ON/OFF” button 40, preferably near the center of the dial 36. The “ON/OFF” button 40 controls the main power to the stand mixer 10. In order to turn the stand mixer off, the “ON/OFF” button 40 is pressed until the mixing process stops and the unit shuts off.

The power/speed control section 32 also contains a “Pulse/Fold” button 42. When this button is pressed, it causes the mixing beaters, such as a flat mixing paddle, chef's whisk or dough hook (not shown) to rotate approximately 1.5 to 2.5 revolutions and then come to a complete stop. This is also known as a “Pulse/Fold” function. The speed of revolution is always at the slowest speed regardless of the speed setting 38. Multiple rotations, or a continuous fold, are possible by the user constantly holding the “Pulse/Fold” button 42 in a depressed position. The “Pulse/Fold” button 42 is released to stop the mixing.

The time control section 34 controls the amount of time that the stand mixer 10 will operate for. This function may or may not be used without affecting the operation of the appliance 10. The amount of mixing time can be entered into the display 44 by depressing the minute button 46 and second button 48 to the desired time. Either button 46, 48 can be held down to scroll through the digits, or the buttons 46, 48 can be pressed and released to advance one digit at a time until the desired time is displayed. However, any other method of input may also be utilized.

The display 44 is preferably in the form of an LCD display. However, in an alternate embodiment, an LED display can be used. The stand mixer 10 will then operate for that amount of time and then automatically stop at the end of the programmed time. Preferably, a tone signals the shutoff of the unit.

In a preferred embodiment, it is also possible to modify the amount of time on the display 44 by pausing the rotation and adjusting the time. The “ON/OFF” button 40 is pressed once to stop the stand mixer and interrupt the countdown. Preferably, a number will flash to signify pause mode. Once the contents of the mixing bowl 18 are checked, the “ON/OFF” button 40 is pressed again. The mixing process begins and the timer continues counting down the remaining time. In a preferred embodiment, there is a safety feature, whereby if there is no action on the unit after 5 minutes, the timer resets itself to “00:00”, a double tone sounds, and the unit shuts off.

The time control section 34 is preferably located on the control panel 30 above the power/speed control section 32. However, in an alternate embodiment, the position of these sections 32, 34 can be reversed. The control panel preferably includes a control panel housing 50, upon which the power/speed control section 32 and the time control section 34 are secured. The control panel housing 50 is preferably secured to the main stand mixer housing 12 by a multitude of flat head screws 52. However, other types of screws, as well as a number of other fastening methods can also be used.

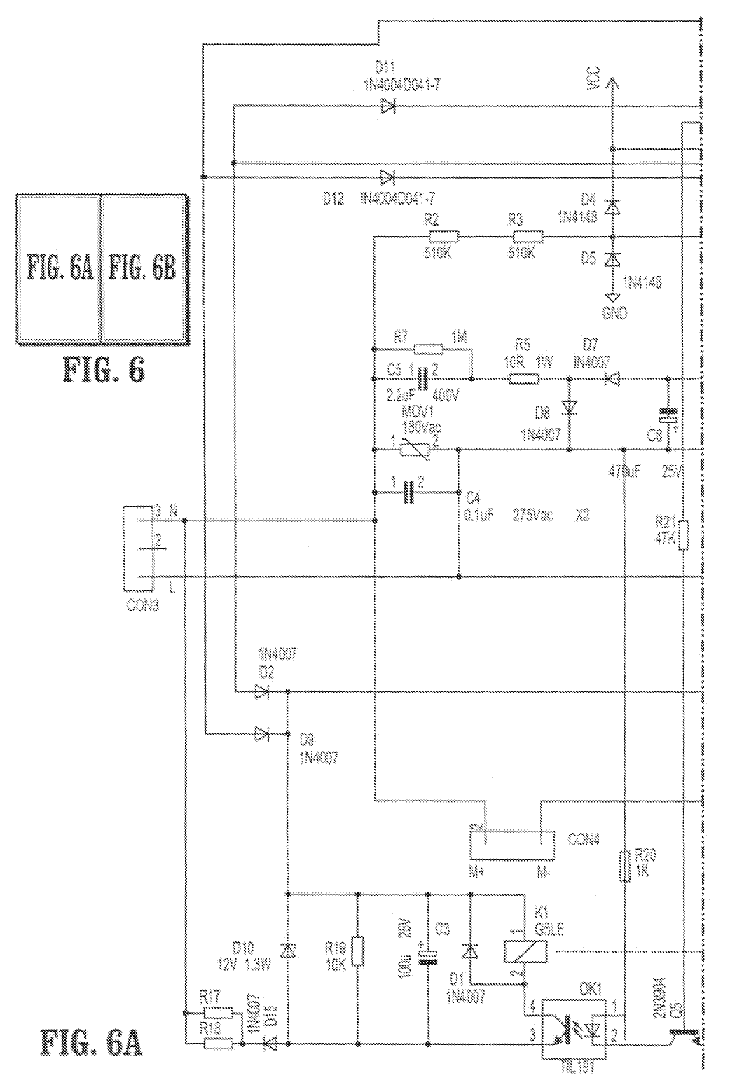

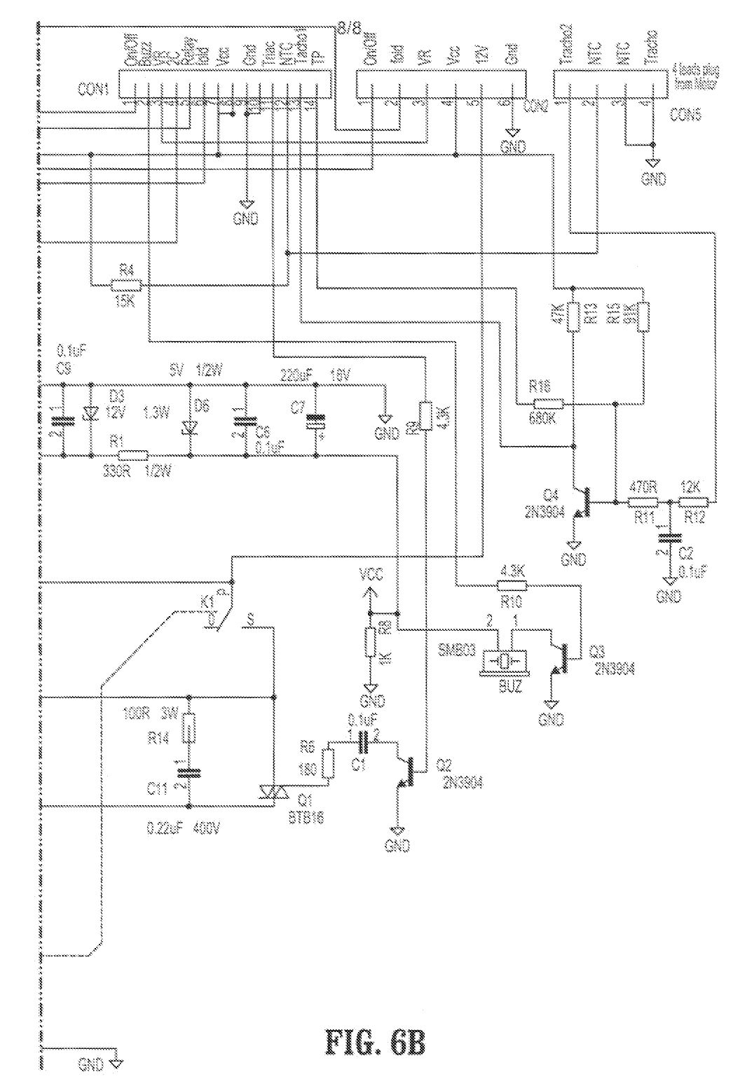

The operation of the stand mixer 10 is controlled by a controller PCB board 54. FIG. 5 shows an example of an electronic circuit diagram to illustrate the components of the controller PCB board 54 used to operate the stand mixer 10, including the LCD display of the control panel 30. FIG. 6 shows another example of an electronic circuit diagram illustrating the operation of the various functions of the stand mixer 10.

While a preferred embodiment of the invention has been herein disclosed and described, it is understood that various modifications can be made without departing from the scope of the invention.

What is claimed is:

1. An appliance comprising:
a housing;
a dial on said housing for controlling a first function; and
a plurality of buttons on said dial for controlling a plurality of additional functions.

2. An appliance according to claim 1, wherein
said appliance is a stand mixer.

3. An appliance according to claim 1, wherein
said additional functions include an on/off function.

4. An appliance according to claim 1, wherein
said additional functions include a pre-set switch to operate said appliance for a predetermined amount of time and then automatically shut off after the expiration of said predetermined amount of time.

5. An appliance according to claim 1, wherein
said dial further comprises a plurality of enumerated speed settings.

6. An appliance according to claim 1, further comprising
at least one input for entering an amount of operation time.

7. An appliance according to claim 1, further comprising
a display to indicate the amount of operation time remaining.

8. An appliance according to claim 6, wherein
said display is an LCD display.
